(19) United States
(12) Patent Application Publication
(10) Pub. No.: US 2002/0174027 A1
(43) Pub. Date: Nov. 21, 2002

(54) Network for media distribution

(76) Inventors: Paul W. Filliger, Keizer, OR (US); Greg R. Nate, Portland, OR (US); Richard P. Laughlin, San Diego, CA (US)

Correspondence Address: Richard T. Laughlin, Esq., Graham, Curtin & Sheridan, 4 Headquarters Plaza, P.O. Box 1991, Morristown, NJ, 07962-1991, US

(21) Appl. No.: 09/861,325

(22) Filed: May 18, 2001

(51) Int. Cl. G06F 17/60

(52) U.S. Cl. 705/26; 705/27

(57) ABSTRACT

This invention relates to an audio and video marketing system. A source of recorded video or audio works is provided for supplying the materials. A main data storage base maintains the audio or video works supplied from the source in storage in a digitized, compressed form. A broadband carrier is supplied for connecting the storage with a local database. The data is supplied to the local storage base as requested by the local base. Means can be supplied for transferring the data from the local storage base onto a portable storage device and for printing associated advertising and identifying data to accompany the portable storage device. Additionally, a sampling protocol is provided between the local database and the main storage data to allow determination of what data is to be transferred.

### FIELD OF THE INVENTION

This invention relates to the distribution of musical compositions and the like, and associated advertising and identification, and particularly to the distribution of such materials over secure networks.

### BACKGROUND OF THE INVENTION

U.S. Pat. No. 5,734,719 issued Mar. 31, 1998 to Tsevdos et al. discloses a digital on-demand system which allows information, such as music, to be reviewed in real time at a station by a customer and then allows selected information to be recorded on a transportable medium at the request of the customer for his purchase and carrying away. The design features are not economically feasible because of the elaborate equipment required at the reviewing station.

U.S. Pat. No. 5,790,935, issued to David W. Payton on Aug. 4, 1998, relates to a system to overcome the limitations of bandwidth and allow substantially on-demand digital information, such as a movie, to a subscriber. A profile of the user is kept and programs which will fit the user's profile are delivered over broadband transmission lines at off peak times to a local storage device maintained by the individual. This reduces the demand at peaks times, since most of the programs the user may demand are in the local storage, and only occasionally will it be necessary to access the broadband capabilities to comply with the user request.

Another form of the prior art is the MP3 system utilizing the Internet for downloading musical works. By this system, musical works are made available at a web site and can be downloaded to a computer hard drive or can be directly transferred to a compact disk (“CD”), such as a mini-disk. A good discussion of such a system appears in Fortune Magazine of Feb. 7, 2000, at page 194. This description relates to downloading music from the Internet and recording it on a small disk, which can then be inserted into a portable player. It utilizes a Voquette NatLink Adapter for transferring the audio to a mini-disk. Voquette has software which allows the user to drag different audio chips into a basket for transmission. The disadvantages of the system are that the recorded quality is poor and substantial time is required for recording.

It is evident that the use of digital networks for transporting commercial quality media carries the potential of significantly reducing expenses and inefficiencies relating to issues such as media duplication, storage, shipping, broad-based availability and meeting unexpected distribution needs.

The music distribution system is under extreme economic pressures. There is an endless variety of music compositions available and the tastes of customers can vary widely, from classical to the latest vogue. For this reason, the economic problems for a music retailer are enormous because of the cost involved in maintaining large inventories. The publisher has to undertake considerable expense to promote the music pieces. Some publishers allow the return of unsold compositions, which then raises economic problems for the publishers. Because of the inventory problems and return possibilities, it becomes extremely difficult to promote new music compositions by lesser known or unknown artists where a market is not assured. The advent of the Internet and the distribution of music compositions over the Internet to customers has been an immense competitive problem to retailers as well as to publishers.

### SUMMARY OF THE INVENTION

In accordance with the invention, a plan is provided to drastically enhance media selection and distribution, dramatically reduce media inventory problems of dealers, promote sales by publishers of large varieties of music compositions and provide customers with quality renditions of both music and video media compositions. This result is achieved with a series of publisher-owned database system (“POD System”) servers that broadcast digital information over a broad bandwidth digital transport network to a large number of area media production systems (“AMPS”) or the like. Each AMPS site is provided with local data storage facilities, equipment to duplicate music compositions on a portable media, such as a CD-writer, and a printer to duplicate labeling and advertising material to be inserted, either manually or automatically, into a media carrying case with the duplicated music or video composition.

The customer is given the opportunity to listen to at least portions of music compositions so he or she can make a selection. This can be accomplished over unsecured telephone lines by the use of the Internet, or by way of a wireless handheld device. This significantly enhances the number of locations for accessing the publisher's media availability, and allows for browsing and purchasing of a broad variety of media. It also eliminates the limitations set by retail preview screens reducing loading and reliance of prior art on limited locations of private bandwidth transmission networks. In addition, with the design enhancement of a wireless browsing access feature, an Internet-compatible wireless device could now access a POD System location and order media for customer pick-up at an AMPS site. A customer could also preview/browse selections from a wireless device from any location.

After the music composition is selected and ordered, the POD System begins the transfer procedure of the files of the composition(s) selected from its data-bank computer to the AMPS site serving the customer request. The POD System identifies, in its own database, if the media being purchased is already presently cached in the database of the AMPS location serving the customer order. If the POD System file shows that the media files requested do exist in the AMPS on-site database, the POD System sends a command authorization, along with customer order certification information, to the AMPS site to authorize the duplication of the media that has been purchased. If not, then the music composition is transferred to the AMPS site for storage and duplication. The POD System also sends purchase identification information to the AMPS site and the requested point of distribution for customer pick-up. The music composition is then quickly transferred to a portable medium, such as a CD or tape, utilizing a duplicating apparatus at the dealer location. Such device, as an example, can be a CD-writer. Associated with the music transmission is the transmission of labeling, advertising and identifying material which can be passed to a printer. maintained by the dealer, and then inserted into the portable medium containing the selected music composition.

As is apparent, AMPS sites may serve media production for several retail outlets in a given area. An AMPS site may be located in a media distribution point in a particular area being served. Further, the economics to the publisher in not having to maintain an inventory is desirable. As to authors and performers of musical compositions, it enables the customer to be exposed to music compositions which would not normally be available because of the economic limits on publishers.

As indicated, in accordance with the invention, music and video compositions are provided through the use of private digital or packet-type network connections for transmission from one of several POD System locations over a switched synchronous private network or equivalent connections to an AMPS site. The media work and any associated labeling and publicity materials is automatically downloaded for the POD System to the appropriate AMPS site for duplication. The material received from the publisher is digitally stored, copied, compressed and catalogued.

The works are downloaded through the digital network connection using a switched synchronous private network to the appropriate AMPS site or satellite location. When a work is requested by a customer, the downloading system automates the file query and transfers the necessary media files to the AMPS site where the work is burned onto a portable storage device, such as a CD or equivalent. The appropriate label or album presentation is downloaded at the same time, printed and applied on the CD, at the AMPS site, either automatically or manually.

As is apparent, one of the advantages of the present invention is that the system materially reduces the expenses of traditional media distribution. The AMPS and media outlet sites can operate in a very small space, which would materially reduce the overhead for both publishers and dealers and also allow such outlets to be placed in areas not previously available to dealers. Payment is made by credit card directly to the POD System with immediate tracking and division with the AMPS site and the appropriate area outlet(s). In addition, the retail outlet location(s) can take over the credit card procedure either in its own operations or by arrangement with the charge card system on direct wholesaled inventory it has had produced through the area AMPS site. A typical payment system is shown in U.S. Pat. No. 5,724,424, issued Mar. 3, 1998 to David K. Gifford, which can be applied to either or both of the customer and the dealer.

Another of the advantages of the invention is that two types of franchises can be created for exclusive areas. One type of franchise would be for area AMPS sites. The other would be for retail outlet and distribution sites. The AMPS site franchises would provide a portion of the high-speed private digital connection. The equipment for operating the AMPS site could be purchased or leased from a certified AMPS provider.

These and other objects and the advantages of the invention will be apparent to those skilled in the art from the following detailed description of preferred embodiments, taken together with the accompanying drawings.

### BRIEF DESCRIPTION OF THE DRAWINGS

For the purpose of illustrating the invention, there is shown in the drawings forms which are presently preferred. It should be understood that the invention is not limited to the precise arrangements and instrumentalities shown.

FIG. 1 is a diagram of an overview of the system.

FIG. 1A is a diagram of the domestic system architecture in accordance with the invention;

FIG. 2 is a diagram showing deployment and network architecture of multiple POD and AMPS locations in the domestic system in accordance with the invention;

FIG. 3 is a diagram of an international system in accordance with the invention;

FIG. 4 is a diagram of a satellite system in accordance with the invention;

FIG. 5 is a diagram of the architecture of the media vending device in accordance with the invention;

FIG. 6 is a diagram of the media vending device showing associated networks and POD location(s);

FIG. 7 is a dimensional view of the vending apparatus that may be used in public environments such as malls and arcades;

FIG. 8 is an elevated drawing showing the discharge and insertion of CDs; and

FIG. 9 illustrates a printer and associated receptacle.

### DETAILED DESCRIPTION OF THE PREFERRED EMBODIMENTS

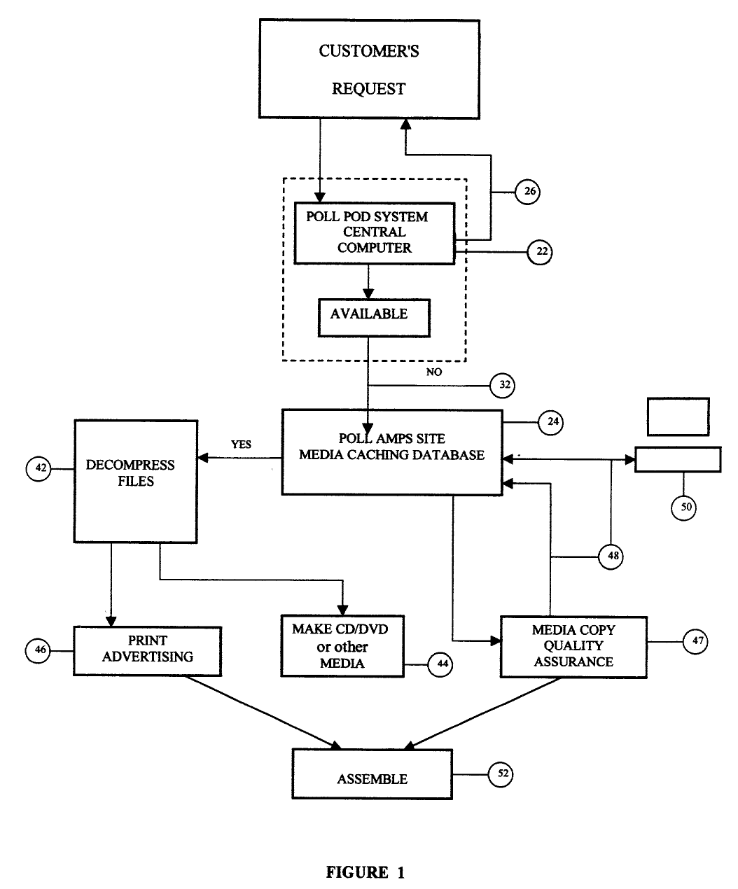

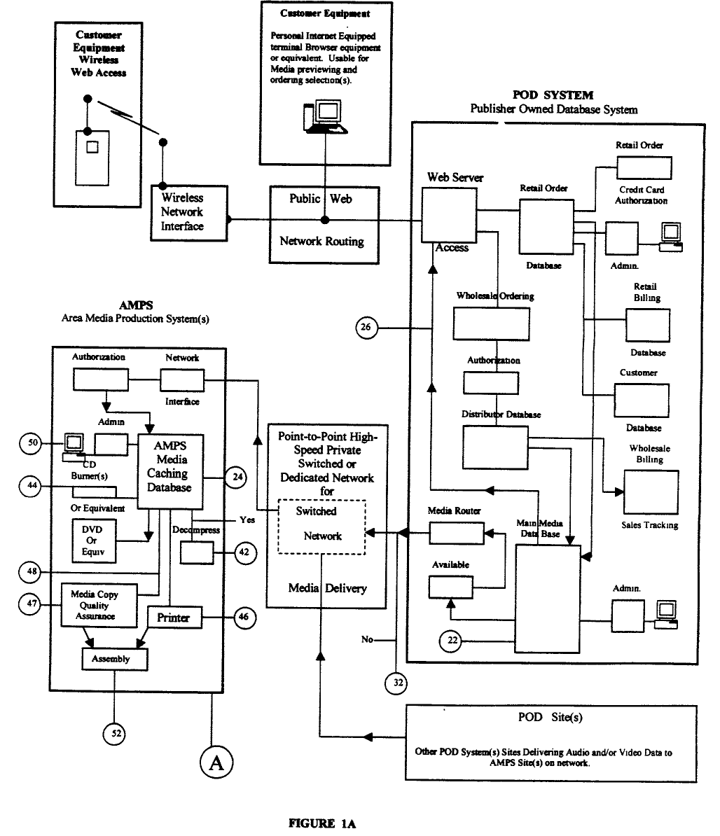

Reference is made to FIGS. 1, 1A and 2 of the drawings. A typical system would perform as follows: Pre-recorded music is obtained from the publisher and stored in digital, compressed, possibly encrypted, files in a central database 22. Each AMPS site is provided with a local caching storage device 24 for retaining any information downloaded for a period of time. Short forms of each composition are selected 26 and are available to allow the customer to preview a music or video composition from the POD System they have accessed from their browser terminal. Any POD System will allow a customer to preview a music composition and order media from a typical PC or other Internet access terminal device through a standard browser Internet connection. The sampling, since it does not require quality reproduction, can be carried over a secure SMDI connection from a POD System over the Internet. The customer makes the selection of the music composition to be purchased by making a menu selection, such as with the use of a point-and-click function on a personal monitor, or by utilizing any other compatible selection method available, such as a wireless handheld device.

The POD System storage device 22 routes the customer to a sample media file for an abbreviated preview of the album requested or of a single selection if made available in that form by the POD System. After a pre-viewed or non-previewed selection has been ordered, the POD System processes and validates the customer credit card transaction based on credit data entered via the customer's Internet terminal connection. The POD System then, within its own data files, determines if the selection being ordered is still cached in the AMPS site that will be used for the production transaction of the media. If it is not available at the AMPS site, the POD System automatically transfers the necessary encrypted files over the high-speed secured digital network to the AMPS site. The downloaded composition is retrieved at the AMPS site and then decompressed and decrypted, if applicable, 42 and recorded on a CD 44 or similar recording medium, i.e., mini-disk, at the AMPS site location. The AMPS files include instructions to a printer 46 which prints out the label and any additional advertising or label information. The paper feed to the printer can be special stock, such as aluminum-coated paper. The AMPS site is equipped to test and validate the commercial production audio or video quality that has been recorded on the CD or DVD. The portable media is placed in the quality test unit 47. The unit then samples media from the CD 48 and displays quality levels on the AMPS site terminal 50. The printer label can be automatically applied to the CD and other printed literature inserted into the CD case 52, or these functions can be done manually. A similar procedure is utilized for transferring other audio information for recording on the CD. A diagram showing one form of this system appears at A in FIG. 1A. A similar system for video transmission is at B in FIG. 2.

As a collateral, a sales promotion can be added where a customer replies to a questionnaire indicating what type of music is preferred and works coming with the selected categories are downloaded to a mailbox on a daily or weekly basis utilizing the Internet. The potential customer can call into the mailbox and review the works for potential purchase. The same system can be utilized to supply streaming music to a commercial location, such as a radio station, for immediate playback or recording for later play.

Each specific AMPS site has file capacity for retaining from 10,000 to 50,000 of the most current popular selections being requested. This file storage will continually and automatically maintain a relatively current popularity status based on the current frequency of the most popular selections being requested. This data-caching feature will eliminate the necessity repeat downloads of encrypted data files to an AMPS site each time a musical or video work is needed for production after the purchase transaction is completed at the POD location. This feature reduces network traffic loading, bandwidth requirements and improves system efficiency.

The POD System can be used for tracking commercial utilization of recorded music or recorded performances for royalty and marketing information. A unique, universally-standardized code ID number can be incorporated into each recording at the point where the original customer copy is manufactured. The coding is encrypted into the digital format and is transparent to the reproduction of the musical piece and to the end user. The encrypted ID number can then be read by supporting software before being aired by a radio station. The unique universal ID of each song aired is stored in a database file at the station location at the time of performance. Performance royalties societies, such as ASCAP, can then remotely poll those performance files and determine performing royalties settlements for the artists and for demographic popularity information.

It is evident that the use of digital networks for transporting commercial-quality media carries the potential of significantly reducing expenses and inefficiencies relating to issues such as media duplication, storage, shipping, broad-based availability and meeting unexpected distribution needs. In application to international distribution, the music is prerecorded and international locations have been authorized to operate under direct business franchises.

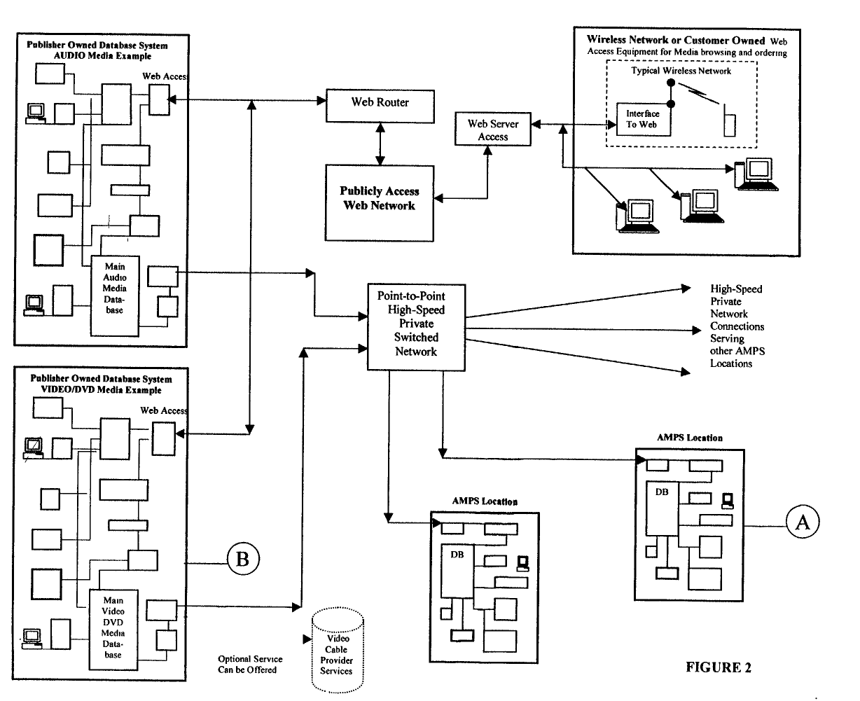

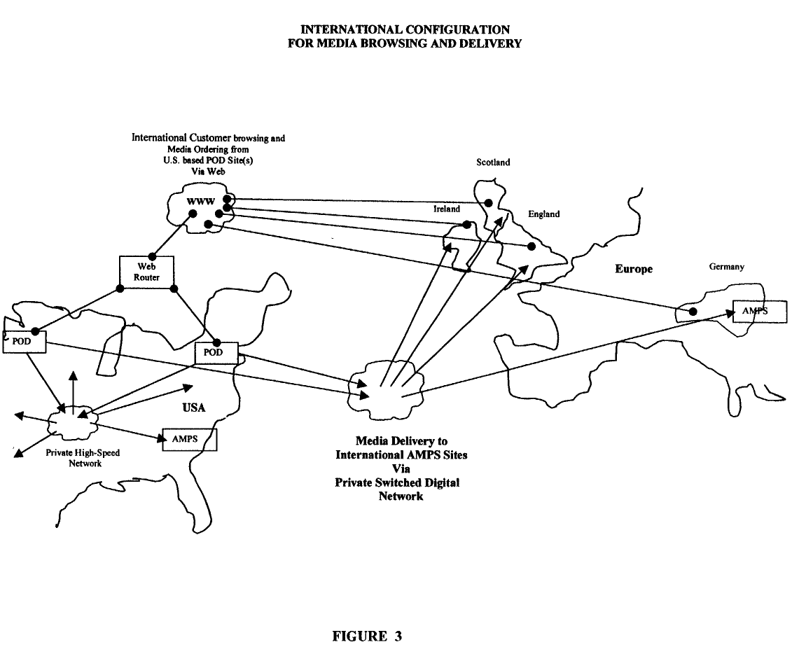

The system can utilize satellites as shown in FIG. 4. The system can be utilized internationally, as shown in FIG. 3. For this illustration, five countries are illustrated—the US, England, Scotland, Ireland and Germany. Each of these database locations, as well as their U.S. counterpart, will be configured with separate cultural music partitions to store the music unique to each country. This type of filing structure will expedite search and find speeds when a browser is querying for one of these particular categories of music.

The main database location is operational in the U.S. The U.S. database can be enhanced to include partitioned files to store each cultural type of music used in the example. A typical small scale system, for example, would be a system for Ireland and Scotland. Each of these systems will be sized and designed similar to a large U.S. retail operation with a storage capacity of 50,000 to 70,000 songs. Each system is given CD- and MP3-reader capabilities for reading, compressing and storing local music files in the system for sale in that country. These local music files will then be packetized and bursted to the U.S. database over a switched digital network for national electronic distribution and sale. The system is equipped with CD-burner and MP3-recorder capabilities for making local copies and is equipped with all necessary system administration database functions. The system is loaded with selected music and documentation files before shipping. Each machine will have its own cultural music file partitions.

The system illustrated for England and Germany is sized and designed to operate as a small main type database location and serve as the hardware and software platform for one retail operation. It is contained within that initial store location. The storage capability of these systems can be modally expandable to house a considerably larger scale database if needed.

The hardware and software is configured to function as the central database location for the small infrastructure of that country's music distribution. High-speed E-1 digital connectivity is one type of network that could be used between sites. E-1 is the European equivalent of the North American standard T-1. It provides a slightly wider digital bandwidth capacity.

Sales and marketing tracking is an integral and required part of the integrity and operation of the international sales system. A sales tracking, marketing authorization software application is incorporated in the architecture of all main or primary database locations. Each satellite location that is functioning as a primary database location will store the “SMART” data information for the retail sites it serves. One central database location will be synchronized to poll the stored “SMART” tracking data from each designated primary database location. Each satellite site can, as an example, have a 60-day caching system for the sales files that act as an off-site back-up for the main database system.

Each musical composition, whether international or domestic, when loaded into the POD System will be automatically assigned a unique “Media, Inc.” classification and tracking number. This number resides in the original compressed file along with the musical selection. Each time the music file is requested at a POD System location, the following information is logged into the accounting summary file of the primary database: Music file number, selection name, site number requesting download and customer profile, site date and time stamp, and related purchase receipt number. This allows the “SMART” software to accurately identify and log each sales transaction associated with each selection or album, and enable the accounting capabilities that summarize royalty and settlement compensations due.

The model offers constant, available bandwidth to all sites at all times over a private synchronous network. This design permits unlimited large-scale selection availability and immediate delivery. Switched digital network resources found in the domestic environment allow such bandwidth availability to be economically feasible.

In similar ways, the switched digital application found in the international network optimizes the economic efficiencies of an international digital network. This is the most cost-effective way to transfer digital data internationally via private network architecture. However, this application imposes economic limitations that are not conducive to small data file bursts that would characterize typical transactions taking place within our domestic network model.

The limiting distinction is that this network applies a circuit set-up charge to the user each time an end-to-end “switched” connection is requested through the cloud and a time-of-day rate based on the time at the point of origination. That is, each time an originating end requests a data transfer connection, a time-of-day-sensitive surcharge is applied to the user's bill. Additional charges are then added for the length of time that connection is maintained. This makes frequent requests for relatively small file sizes economically costly and unfeasible. The only efficient way to utilize the economy of this switched digital service application is by bursting (speed downloading) larger scale files each time a request for transfer is made. For our application, file sizes would only become large scale if several transaction requests were stored at a main database site and downloaded to distant location together.

If stateside browsing and purchase requesting was allowed via the Internet, credit-card authorization capabilities, such as LIDBI, would need to be implemented at the stateside database. Payment would need to be authorized or secured before the purchase request was accepted. Transaction and authorization information would need to be transferred to the international sites at the time the music files were forwarded. If partial policy is used, the final purchase transaction would take place at the store site when the merchandise was picked-up by the customer.

The international switch digital network connection could be used to send international music file to the U.S. database for presentation and sale. File sizes would be accumulated at each primary site and downloaded to the main stateside site at optimized network times.

There is one possible way to maintain the international market delivery concepts employed by this current model while eliminating the use and expense of the switched digital network connections. This could be accomplished by downloading the accumulated files via a high-speed (broadband) connection to the Internet.

Transaction requests to the U.S. site would be made and stored during one business-day cycle. The requests would be filled during the intermediate non-business hours in time for the next international business day's deliveries. Conversely, new international music would be copied, compressed and transferred to the U.S. database via a high-speed connection over the Internet. This type of data transfer solution could become a possible usable option due to the next-day delivery model that has been presented.

It is important to realize, in using such a network, there are also inherent liabilities that could affect data transfer reliability and quality at times. Such network issues may include network blockage or downtime, packet collision due to excessive traffic and loss of asynchronous data arrival. This could result in partial corruption of digital file structure during transfer which could produce audio distortion in the reproduced music media copy. Such corruption could also result in loss of definable associated administrative tracking information or other support file information. All of these issues become trade-offs of economy versus reliability when moving away from the use of a private network for the transfer of critical information.

As an alternative, a switched network could be used for the transfer of all quality critical files, such as audio-related files, and the Internet could be used for the transfer of all other non-critical information. The related information would then need to be merged at the receiving location. These are some of the issues that may be considered to optimize the efficiency and economy of this type of deployment effort.

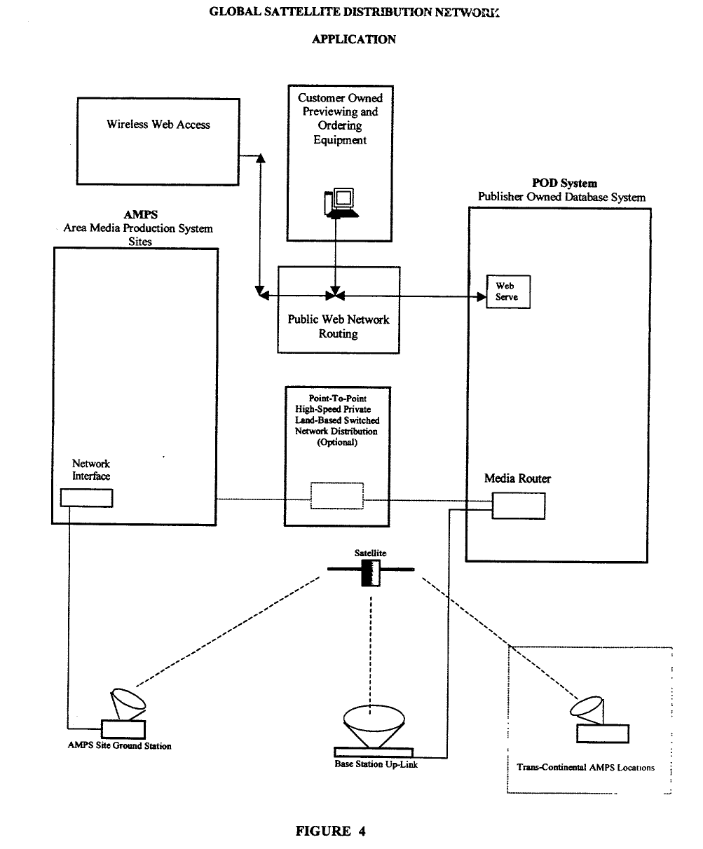

Additional enhancements would include CD- and MP3-reader capabilities at international retail outlets. A typical device is shown in FIG. 5 which could be maintained at any desired location. This would allow musical works from those countries to be compressed and uploaded into the local databases, then to be bursted to U.S. databases for distribution and sale.

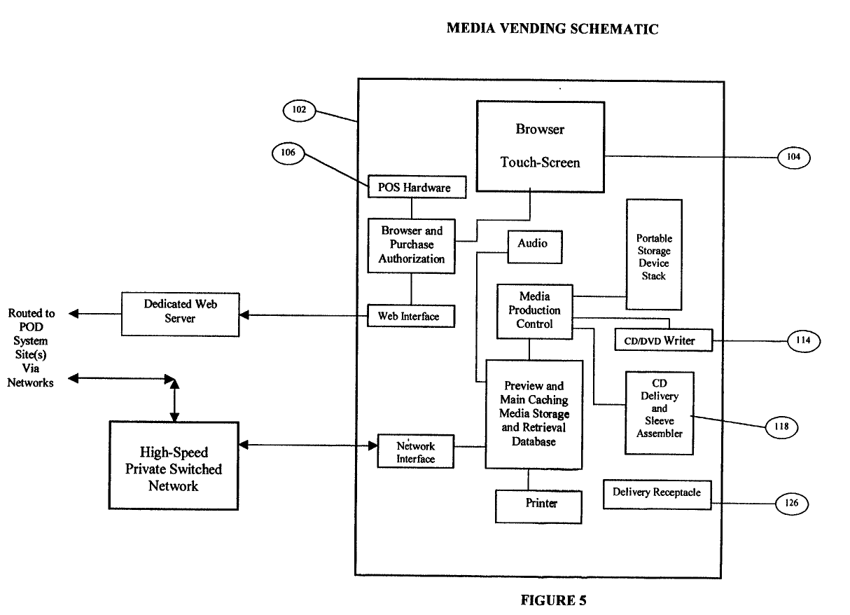

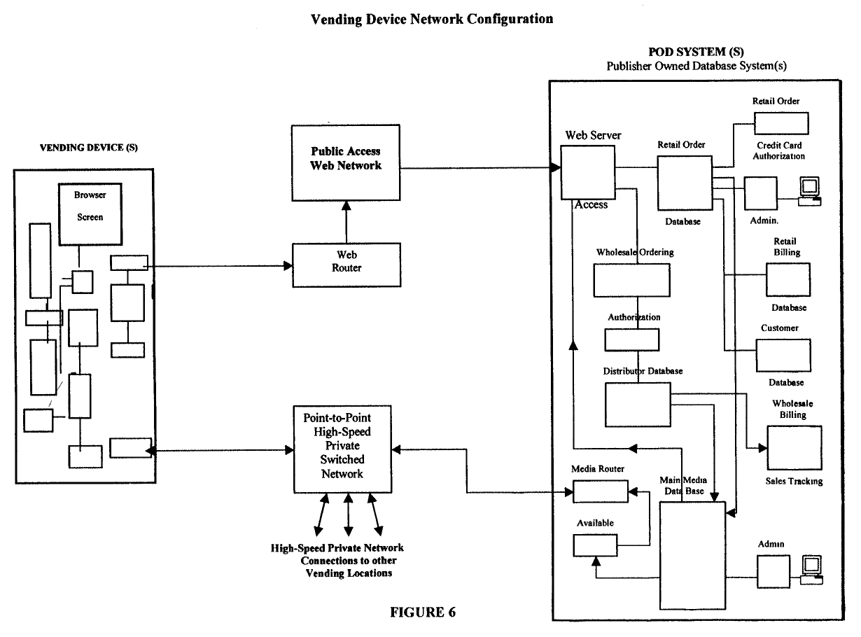

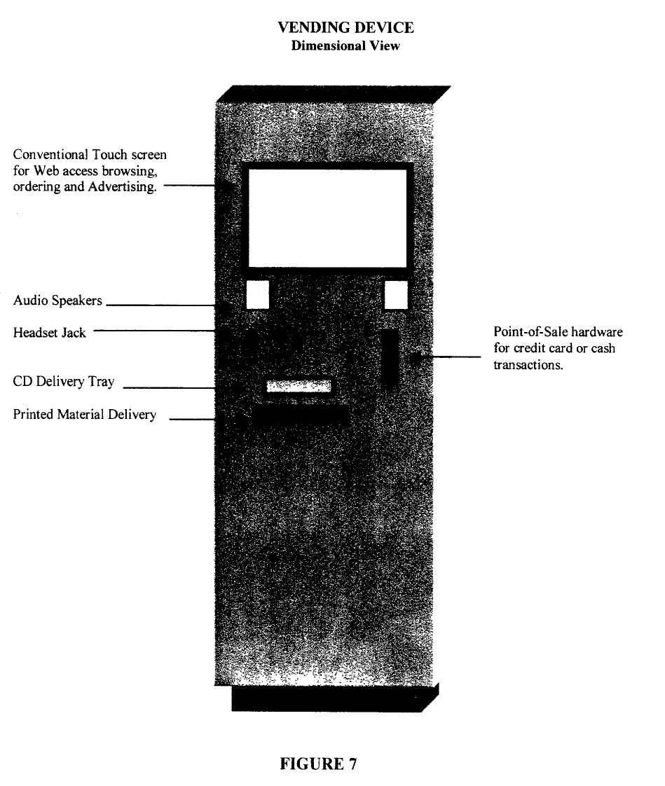

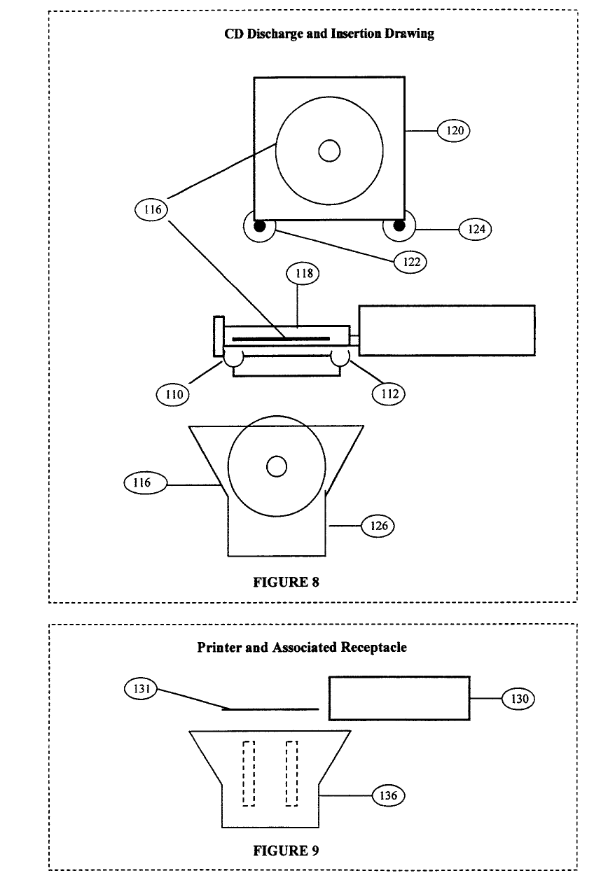

Referring to FIGS. 5 and 6, a vending machine device is illustrated which can be placed in any location to enable a customer to obtain a completed CD bearing the musical composition selected by the customer. The CD is supplied with a case and any indemnifying or advertising matters supplied. A case 102 is provided which has a touch-screen monitor 104. The monitor displays a series of menus listing the musical compositions available. The menus can be arranged, for example, by classification such as composer, singer or type of music such as classical, jazz, rock and the like. The customer touches the menus at his or her selection, is informed of the cost and given the opportunity to make payment. The customer inserts the cash or a credit card at 106 to pay for the purchase utilizing a system such as shown in U.S. Pat. No. 5,724,424. The completed payment causes a signal to be issued requesting the selected composition. The musical composition is then downloaded to the vending machine where it is burned onto a CD by utilizing a CD writing device 114. Upon completion of the transfer, the tray 118 holding the CD 116 moves out of the recording mechanism and contacts a series of cams 110, 112 which removes the CD 116 from the tray. When the CD is removed from the tray, a new CD is placed in the tray from a supply container 120 by activating cams 122 and 124. The discharged CD is released to a receptacle 126 which allows the customer to remove the CD from the vending machine. As the musical composition is transferred, instructions are issued to the printer for printing the label and any desired advertising material. The printer 130 then prints the material 131 and discharges it to the receptacle 136 to allow the customer to assemble in a container, not shown, which is also discharged at the same time.

Although the present invention has been described in connection with musical compositions, it is equally suitable for use in video transmission or any other type of data which requires selection and associated materials. The present invention may be embodied in still other specific forms without departing from the spirit or essential attributes thereof and, accordingly, the described embodiments are to be considered in all respects as being illustrative and not restrictive, with the scope of the invention being indicated by the appended claims, rather than the foregoing detailed description. Furthermore, the appended claims indicate the scope of the invention, as well as all modifications which may fall within the range of equivalency, which are also intended to be embraced therein. Any modification of the claim language resulting in the prosecution of this patent application is not intended to limit the range of equivalency.

What is claimed is:

1. An audio and video marketing system comprising: a source of recorded video or audio works, a main data storage base for maintaining the audio or video works supplied from the source in storage, means for digitizing the video or audio works in the storage base, means for compressing the video or audio works in the storage base, means for customer ordering from AMPS, an AMPS local database receiver, a broadband carrier means connected between the storage and the local database, means associated with the local database for receiving one or more of the audio or video works, and means for transmitting on the broadband transmission means from the storage base to the local database for receiving the video or audio works selected.

2. The system as defined in claim 1 wherein recording means associated with the AMPS database records the streaming transmitted audio or video works on a removable media.

3. The system as defined in claim 1 wherein the carrier means is a synchronous broadband digital.

4. The system as defined in claim 1 wherein the carrier means is optical cable.

5. The system as defined in claim 1 wherein advertising or display copy materials associated with one or more of the audio or video works are supplied from the source, a printer means associated with the local database, means for transmitting on the carrier means the associated advertising or display material from the storage database to the printing means, and means for applying the printed material associated with the audio or video on the removal disk.

6. The system as defined in claim 1 including means for preparing samples of the video or audio works, means associated with the receiving computer for selecting one or more of the samples for preview, means for transmitting on demand one or more of the samples between the storage database and the local database, and means for previewing the samples selected.

7. The system as defined in claim 5 including a display means for selecting the samples to be viewed.

8. The system as defined in claim 1 including an indicating means associated with the storage database for selecting the video or audio work to be transmitted.

9. An audio and video marketing system comprising: a source of recorded video or audio works, a storage database for maintaining the audio or video works in storage supplied from the source, means for digitizing the video or audio works in the storage base, means for compressing the video or audio works in the storage base, means for selecting a program of video or audio works, a local database for receiving, broadband carrier means connected between the storage base and the local receiving database, means for transmitting on the broadband transmission means from the storage base to the local receiving base the selected program, means for assembling a program of works, and broadcasting the program.

10. The system as described in claim 9 wherein each separate work is coded for remotely recording the times it was broadcast.

11. A vending machine comprising a housing, CD-writer/recording device, a touch display screen, means for displaying menus on the touch-screen, communication means to act as a result of a menus selection to transfer to the write recording device the musical composition selected, discharge means for discharging the recorded CD, printer means for reacting to instructions transferred with the musical device, means for discharging to a receptacle the printed materials, a supply means for holding CDs and, when instructed, for supplying a disk to the recording device and supplying means for supplying a container for the CD to the receptacle.

12. The vending machine in accordance with claim 11 wherein the CD records a video.
